(19) United States
(12) Patent Application Publication
(10) Pub. No.: US 2017/0018071 A1
(43) Pub. Date: Jan. 19, 2017

(54) METHOD AND SYSTEM FOR IMAGING A LUMBER BOARD, METHOD OF CALIBRATING AN IMAGING SYSTEM AND CALIBRATION IMPLEMENT THEREFORE

(71) Applicant: VAB SOLUTIONS INC., Levis (CA)

(72) Inventors: Marc Voyer, Quebec (CA); Jean Bérubé, Levis (CA); Emmanuel Jolys, Quebec (CA)

(21) Appl. No.: 15/205,163

(22) Filed: Jul. 8, 2016

Related U.S. Application Data
(60) Provisional application No. 62/191,786, filed on Jul. 13, 2015.

(51) Int. Cl. G06T 7/00; G06T 7/40; H04N 5/232

(52) U.S. Cl. CPC G06T 7/0004; G06T 7/0024; H04N 5/23229; G06T 7/408; G06T 2207/10024

(57) ABSTRACT

The method of imaging a lumber board generally has the steps of: emitting laser light along a laser plane and toward a transit plane from both opposite sides thereof, in a manner to form a pair of opposite transversal lines of laser light on the lumber board as the board is conveyed across the laser plane; recording a plurality of images of the transversal lines of laser light as the board is conveyed across the laser plane, with each image being associated to a corresponding longitudinal position of the board along the transit plane; and producing a mapping of the geometry of the board by correlating, for each one of the images, the position of points located along the transversal lines of laser light in the recorded images with tridimensional coordinates in a conveyor reference system using tracking data indicative of the movement of the lumber board and calibration data.

### BACKGROUND

In the lumber industry, dimensions and quality (grade) are important variables which affect the pricing of boards of dimensional lumber. Amongst variables indicative of quality are geometry and presence of other perceivable imperfections (e.g. knot, wane, bending, torsion). There remained room for improvement in terms of systems and methods allowing to assess the quality of dimensional lumber boards.

### SUMMARY

This specification provides a detailed description of an embodiment of a system (and associated method) which allows to assess dimensional lumber by imaging the boards as they are being conveyed in a transversal orientation by a lug chain conveyor. The imaging of the boards can be performed using a combination of cameras and flat laser emitters in a manner to simultaneously obtain geometry data and coloring data of the boards—the geometry data being usable to assess the presence of geometrical imperfections and the coloring data being usable to assess the presence of color imperfections such as knots, rot and/or wane for instance. A method of calibrating the system and a calibration implement for use in the method of calibration are also described.

In accordance with an aspect, there is provided a method of imaging a lumber board as the lumber board is being conveyed along a longitudinal transit plane by a conveyor, the conveyor having a frame, a conveyor reference system being associated to the frame, the method comprising: emitting laser light along a laser plane and toward the transit plane from both opposite sides of the transit plane, in a manner to form a corresponding pair of opposite transversal lines of laser light on the lumber board as the lumber board is conveyed across the laser plane, the laser plane intersecting both the transit plane and a plane normal to the transit plane along a central axis; from points-of-view on both sides of the transit plane and spaced apart from the laser plane, recording a plurality of images of the transversal lines of laser light as the lumber board is conveyed across the laser plane, with each image being associated to a corresponding longitudinal position of the lumber board along the transit plane; and using a computer, producing a mapping of the geometry of the board by correlating, for each one of the images, the position of a plurality of points located along the transversal lines of laser light in the recorded images with tridimensional coordinates in the conveyor reference system using tracking data indicative of the movement of the lumber board as it is conveyed across the laser plane, and calibration data associated to the corresponding points-of-view.

In accordance with another aspect, there is provided a system for imaging a lumber board as the lumber board is being conveyed along a longitudinal transit plane by a conveyor, the conveyor having a frame and a conveyor reference system associated to the frame, the system comprising: a laser emitter subsystem having a plurality of laser emitters being mountable to the frame for emitting laser light, along a common laser plane, toward the transit plane, and from both opposite sides of the transit plane, in a manner to form a corresponding pair of opposite transversal lines of laser light on the lumber board as the lumber board is conveyed across the laser plane, the common laser plane intersecting both the transit plane and a plane normal to the transit plane along a central axis; a camera subsystem having a plurality of cameras being mountable to the frame for recording a plurality of images of the transversal lines of laser light as the lumber board is conveyed across the laser plane, at corresponding points-of-view being fixed in the conveyor reference system, located on each side of the transit plane, and being spaced apart from the laser plane, the camera subsystem being connectable to transfer the recorded images onto a computer; a tracking subsystem for tracking the movement of the lumber board as it is conveyed across the laser plane and producing tracking data indicative thereof, the tracking subsystem being configured and adapted to transmit a data feed to the computer; and a software program product loadable to the computer and having a set of instructions executable by the computer for producing a mapping of the geometry of the board by correlating the position of a plurality of points located along the transversal lines of laser light in the recorded images with tridimensional coordinates in the conveyor reference system using the tracking data, and calibration data associated to the corresponding points-of-view.

In accordance with another aspect, there is provided a method of imaging an object moving along a longitudinal transit plane relatively to a reference system, the method comprising: emitting laser light, along a laser plane being fixed in the reference system and toward the transit plane, in a manner to form a transversal line of laser light on the object as the object is moved across the laser plane in the reference system, the laser plane intersecting both the transit plane and a plane normal to the transit plane along a central axis; recording a plurality of images of the transversal line of laser light as the object is moved across the laser plane, from at least one point-of-view being fixed in the reference system and being spaced apart from the laser plane; tracking the movement of the object as it is conveyed across the laser plane and producing tracking data indicative thereof; and using a computer, producing a mapping of the geometry of at least a portion of the object by correlating the position of a plurality of points located along the transversal line of laser light in the recorded images with tridimensional coordinates in the reference system using the tracking data, and calibration data associated to the at least one point-of-view.

In accordance with another aspect, there is provided a method of calibrating an imaging system for imaging a lumber board as the lumber board is being conveyed along a longitudinal transit plane by a conveyor, the conveyor having a frame and a conveyor reference system associated to the frame, the imaging system having a laser emitter subsystem for emitting laser light along a common laser plane intersecting both the transit plane and a plane normal to the transit plane along a central axis, and a camera subsystem having a plurality of cameras being mounted to the frame at corresponding points-of-view located on each side of the transit plane, and being spaced apart from the laser plane, the method comprising: a first step of mounting a calibration implement to the frame on a second side of the laser plane and with a calibration face of the calibration implement coinciding with the laser plane, the calibration face having reference features thereon; a first step of aligning a field of view of a first one of the cameras with the calibration face of the calibration implement and obtaining an image of the calibration face with the first camera, the first camera having a point of view located on the first side of the laser plane; using a computer, determining a position and an orientation of the calibration face in the image obtained from the first camera based on a recognition and a measurement of the reference features in the image, and using the determined position and orientation in producing calibration data for the first camera; a second step of mounting the calibration implement to the frame on the first side of the laser plane and with a calibration face of the calibration implement coinciding with the laser plane, a second step of aligning a field of view of a second one of the cameras with the calibration face of the calibration implement and obtaining an image of the calibration face with the second camera, the second camera having a point of view located on the second side of the laser plane; using a computer, determining a position and an orientation of the calibration face in the image obtained from the second camera based on a recognition and a measurement of the reference features in the image, and using the determined position and orientation in producing calibration data for the second camera.

In accordance with another aspect, there is provided a calibration implement for calibrating a camera based on an actual position of a laser plane in a field of view of that camera, the calibration implement comprising a calibration implement body having a given thickness and a calibration face having reference features recognizable by a computer when imaged by the camera, and a spacer positionable against the calibration face of the calibration implement, wherein the thickness of the spacer corresponds to a thickness of the calibration implement without the spacer.

Many further features and combinations thereof concerning the present improvements will appear to those skilled in the art following a reading of the instant disclosure.

### DESCRIPTION OF THE FIGURES

In the figures,

FIG. 1 is a partial and front view of an imaging system for imaging a lumber board as it is being conveyed along a lumber path and across an imaging area, in accordance with an embodiment;

FIG. 2 is a schematic view of a lumber board being conveyed across a laser plane at different, successive moments of time, in accordance with an embodiment;

FIG. 3 is an oblique view of an example of a lug chain conveyor with three parallel lug chain assemblies, in accordance with an embodiment;

FIG. 4 is a front view of the lug chain conveyor shown in FIG. 3, in accordance with an embodiment;

FIG. 5 is an oblique view of a housing incorporating a laser emitter and a camera; in accordance with an embodiment;

FIG. 6 is a block diagram of an imaging system for imaging a lumber board, in accordance with an embodiment;

FIG. 7A is a front view of a laser alignment implement, in accordance with an embodiment;

FIG. 7B is a front view of an example of a camera calibration implement, in accordance with an embodiment;

FIG. 7C is a front view of another example of a camera calibration implement with spacers, in accordance with an embodiment;

FIG. 8 is a flowchart of an example method of calibrating an imaging system for imaging a lumber board, in accordance with an embodiment;

FIG. 9 shows an enlarged view of a raw image of a camera calibration implement, in accordance with an embodiment;

FIG. 10 is an example of a processed image of a laser line showing a coordinate reference mapping, in accordance with an embodiment;

FIG. 11 is a schematic view used to explain profile calculation in accordance with an embodiment;

FIG. 12 is a graph showing a lumber board profile of a lumber board, in accordance with an embodiment;

FIG. 13A is a top view image of an upper face of a lumber board, in accordance with an embodiment;

FIG. 13B is an exemplary graph showing color data as a function of a length of the lumber board shown in FIG. 13A, in accordance with an embodiment; and

FIG. 13C is an exemplary graph showing color data as a function of a width of the lumber board shown in FIG. 13A, in accordance with an embodiment.

### DETAILED DESCRIPTION

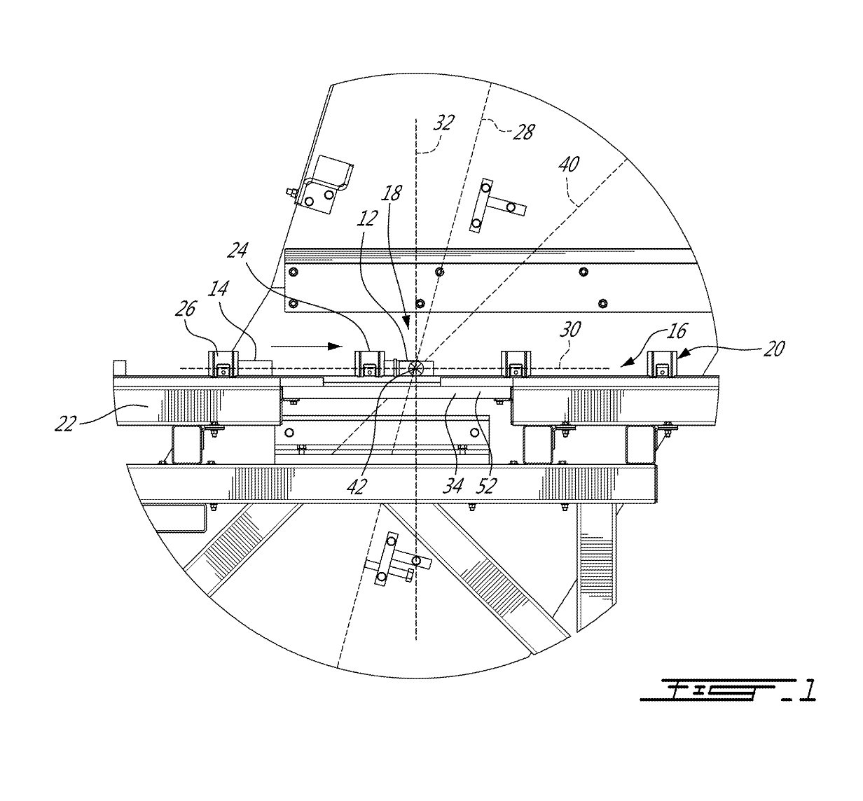

FIG. 1 schematizes the imaging dimensional lumber boards 12, 14 as they are being conveyed along a lumber path 16 and across an imaging area 18. The conveyor 20 has a frame 22 sturdy enough for the lumber path 16 to be considered to remain fixed within a reference system of the frame 22. It is noted here for ease of reference that in this specific example, the conveyor 20 is a lug chain conveyor which conveys transversally-oriented dimensional lumber boards 12, 14 in a longitudinal orientation corresponding to the length of the chains (not shown), and that the dimensional lumber boards 12, 14 are each engaged with a corresponding set of transversally-aligned lugs 24, 26 in a manner that the boards 12, 14 are maintained spaced apart from one another along the length of the chains as they are conveyed across the imaging area 18. It will be understood that the system can be used with a different conveyor in alternate embodiments.

Laser light is emitted along a plane, which will be referred to herein as the laser plane 28 for convenience, from both sides of the lumber path 16. The laser plane 28 here is fixed relative to the frame 22 (i.e. is fixed in the frame reference system). The laser light forms two opposite transversal laser lines on boards 12, 14 which are conveyed across the laser plane 28 by the conveyor 20. For the purpose of reference, in this specification, a transit plane 30 will be defined as being parallel and coinciding with the lumber path 16 where the lumber path 16 intersects the laser plane 28. Moreover, a normal plane 32 will be defined as being normal to the transit plane 30 and intersecting the laser plane 28 in the lumber path 16. As shown in FIG. 1, the transit plane 30 and the normal plane 32 form four quadrants. It will be noted here that in this embodiment, the laser plane 28 is inclined both relative to the transit plane 30 and to the normal plane 32, and extends across two opposite quadrants. The transversal laser lines are applied not only to the faces (here horizontal and parallel to the transit plane), but also to the edges (here vertical and parallel to the normal plane) of boards conveyed thereacross. The entire width and thickness of the boards (save partial “blind spots” imparted in particular by the rails 34 supporting the lug chains under the boards 12, 14) are “scanned” by the transversal laser lines once the boards 12, 14 have been fully conveyed across the laser plane. The laser light can be emitted by laser emitters positioned on both sides of the transit plane 30 and referenced herein as collectively forming part of a laser subsystem. The angle of inclination between the laser plane 28 and the transit plane 30 is denoted α in FIG. 1.

Still referring to FIG. 1, the system further has a camera subsystem having at least a pair of cameras (not shown in FIG. 1) having a field of view which is adapted to encompass the transversal laser lines on both sides of the lumber path 16 during use. The cameras are positioned at corresponding points of view on both sides of the transit plane 30 and can be fixed in the reference system of the frame 22. To allow imaging, recognition, and triangulation of the corresponding transversal laser lines during movement of the lumber boards 12, 14, the points of view of the cameras, while being in the same quadrant as the corresponding laser emitters, are spaced apart from the laser plane and can be said to form an inclination angle γ therewith.

The cameras can be calibrated (an example of a calibration method will be described below) with reference to the position of the laser plane 28 (and thus inherently within the frame reference system), in a manner that, knowing that the transversal line will necessarily be moving within the laser plane between different images taken by the camera due to the thickness of the lumber boards, the precise coordinates of points along the transversal line can later be associated to corresponding 3D coordinates within the frame reference system using the calibration data. This can be performed by a process of triangulation.

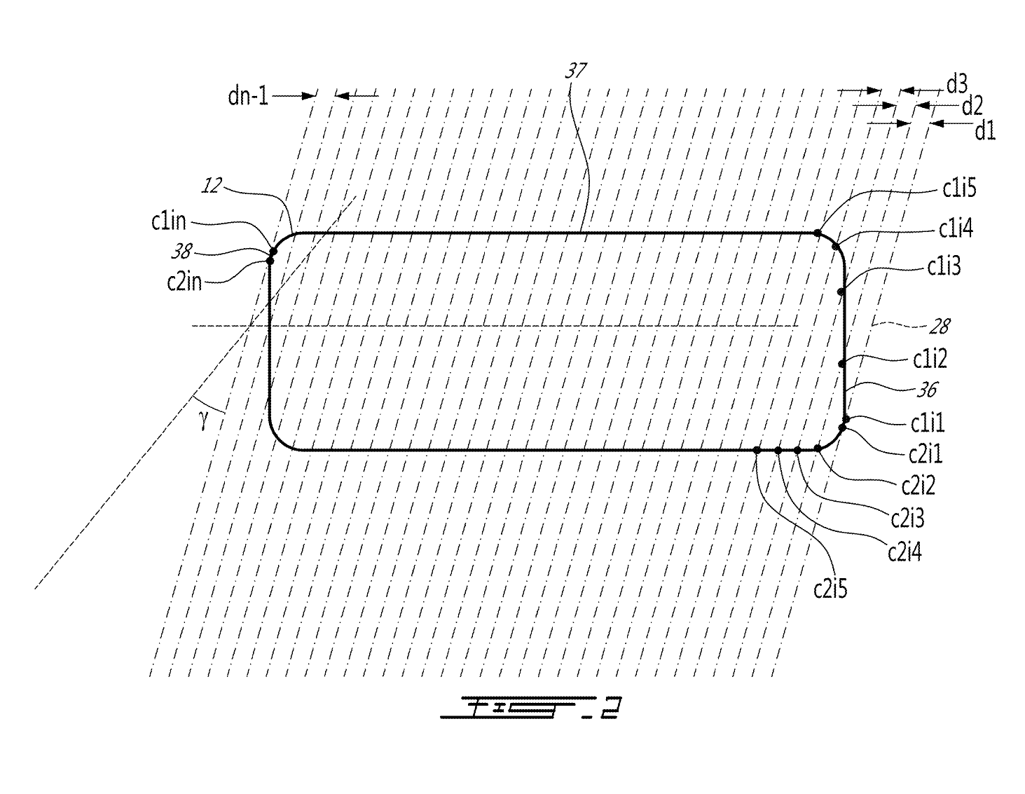

To ease understanding and for ease of reference, a schematic view is presented in FIG. 2. This view schematizes the relative movement between the board 12 and the laser plane 28 by showing various positions of the laser plane 28, although it will be understood that in this example, it is the boards 12, 14 which are moved while the laser plane 28 remains fixed relative to the frame. With reference to this figure, it will be understood that as the board 12 is conveyed to and across the laser plane 28, the laser light eventually reaches a leading edge 36 of the board 12, forming a first transversal laser line thereon (represented as point c1i1 in the cross-sectional view of FIG. 2) generated by the laser emitter positioned above the board, and a second transversal laser line c2i1 generated by the laser emitter positioned below the board. Initially, these two laser lines coincide, and are represented by the bullets c1i1 and c2i1 in FIG. 2, and subsequently spread apart, each following an opposite surface of the board 12, until they eventually recombine at the trailing edge 38 of the board 12. During this process, the cameras positioned above and below can record a plurality of digital images. In the schematic view, points c1i1 and c2i1 represent the position of the laser lines at the moment where a first image is taken by cameras 1 and 2, respectively. Points c1i2 and c2i2 represent the position of the laser lines at the moment where the second image is taken. In the second image, the board and the laser plane have undergone a given longitudinal relative displacement d1. At the moment when the third image is taken, the board has been further moved relative to the laser plane by the longitudinal distance d2, the transversal lines then being at positions c1i3 and c2i3. Successive images are taken at the different points shown, until they eventually rejoin at the trailing edge at positions c1in and c2in. Typically, the board will be moved at constant speed by the conveyors and the cameras will be operated to take images at a constant frame rate, which leads to a constant longitudinal distance between images. However, it will be understood that the speed of the boards, the frame rate, or both, can vary during the displacement of the board in alternate embodiments. In a scenario where the frame rate and displacement speed are constant, the longitudinal distance of movement of the board between subsequent images can be constant, which can simplify data analysis. It can also be useful to synchronize upper and lower cameras of the pair so that the images taken by one camera can be directly associated to corresponding images taken by the other camera at the same moments in time.

Geometrical data can thus be obtained by taking the series of images with the cameras as the board 12 is being conveyed by the conveyor 22, or, otherwise said, by “filming” the progress of the transversal laser lines with the cameras while the cameras and laser plane 28 remain fixed and the board is conveyed across the laser plane. The images can each be initially attributed temporal coordinates. In order to obtain a greater or satisfactory degree of precision, a conveyor tracking device can be used to provide tracking data which can be used to precisely track the position of the board along the lumber path at the given temporal coordinates and therefore determine the values d1, d2, . . . , with reference to the schematic view of FIG. 2, with a satisfactory degree of precision. Alternately, a device such as an optical encoder can trigger the cameras based on the detected position of the lug chain. In any event, the data used to associate the traces of the transversal laser lines on the images to given longitudinal coordinates along the width of the board can be referred to herein as tracking data. It will be understood that this “tracking data” can be obtained directly, such as by determining the longitudinal position of the board at each temporal coordinate, or alternately, be obtained indirectly, such as by determining a relative longitudinal position of the board along the lumber path based on a known or a measured travelling speed for instance. In one variant, only the presence and positions of points located along the transversal laser lines in the images are recorded whereas in another variant, the detected intensity at each point is also recorded in order to allow the determination and characterization of eventual imperfections in the board. For the purpose of this disclosure, this type of imperfection will be referred to as color-related imperfections as encompassing shade-related imperfections, since in some embodiments, color images can be used instead of black and white (intensity-only) images. The choice of the expression “color” is made is made for the purpose of simplicity, and is not intended to exclude measures of intensity at a single wavelengths rather than across a spectrum.

If the ratio between the frame rate of the imaging and the speed of conveyance is sufficient, the images obtained can be satisfactorily representative of the entire external surface of the board. A computer can then be used to establish a 3D model of the geometry of the board using the position and shape of the transversal lines in the field of view of the cameras for the given set of temporal coordinates and both i) the calibration data of the cameras used to take the images and ii) the tracking data used in establishing the longitudinal position or displacement, absolute or relative, of the board relative to the laser plane along the lumber path for each set of temporal coordinates. In the embodiment described in greater detail below, an optical encoder is used to trigger the temporal coordinates of the cameras based directly on a reading of displacement of the lug chain conveyors.

If, as in the detailed embodiment presented below, the cameras are cameras which further allow to determine at least an intensity of light for each pixel in addition to the position and shape of the transversal laser line, the intensity reading can be used to obtain color data, the analysis of which allows both the determination of color-related imperfections and their geometrical coordinate determination in a 3D mapping of the contour surface of the board. The expression “color data” is used as encompassing shade data obtained in the context of an embodiment where intensity is measured at one wavelength rather than more than one wavelength (e.g. across a spectrum of colors).

Referring back to FIG. 1, in this specific embodiment, it was found convenient to align both cameras of each pair on opposite sides of the lumber path 16 to face one another along a plane which will be referred to herein as the imaging plane 40 and which can also be fixed in the frame reference system. The imaging plane 40 is also inclined both relative to the transit plane 30 and to the normal plane 32. The angle of inclination of the imaging plane relative to the transit plane 30 is denoted β in FIG. 1. Furthermore, in this embodiment, the imaging plane 40, laser plane 28, and transit plane 30 all intersect a common axis 42 referred to herein as the central axis 42 for ease of reference, and the imaging plane 40 and the laser plane 28 are both inclined relative to one another such that α and β are different. The relative inclination between the laser plane 28 and the imaging plane 40, denoted γ in FIG. 1, plays a role in the ability of the system to obtain geometrical data concerning a board 12 conveyed across the laser plane 28 (by calibration and triangulation). For instance, as a board 12 is conveyed across the laser plane 28 and the transversal laser line sweeps the edge 36 and the face 37 of the board 12, the transversal laser line will always remain in the laser plane, but its image will change in the field of view of an associated camera given the presence of the triangulation angle γ. If the board is warped, the transversal laser line will appear curved in the field of view of the associated camera, and the importance of the curve (and thus the sensitivity) will be directly related to the importance of the angle γ. Henceforth, for a given angle γ, analyzing the varying positions and shapes of the transversal laser lines in the field of view of the cameras as the board is conveyed across the laser plane can allow to obtain geometrical data.

In the embodiment presented in detail in the associated figures, it was selected to incline the imaging plane at β=45° in order to obtain comparable images of the edges of the boards (normal to the transit plane) and the faces of the boards (parallel to the transit plane). Concerning the inclination of the laser plane, it will be understood that while there is a motivation to increase the angle γ in order to increase the “3D” effect, it should also be considered that making the angle β depart from 45° will lead to unequal imaging between the faces and the edges. Indeed, if the speed of the board remains constant across the laser plane 29, the transversal laser line will pass faster on a corresponding one of the face 37 and the edge 36 than the other. To a certain extent, this feature of unequal illumination can be considered tolerable. The amount of this tolerable extent will depend on variables such as the speed of the boards along the transit path 30, the frame rate of the cameras, and the desired imaging accuracy. In the embodiment illustrated, γ was selected to be of 30°, which left 15° of inclination between the laser plane and the normal plane. This value was found to be satisfactory both in providing a satisfactory 3D effect and in allowing sufficient imaging of the edges of the boards. It will be understood that the actual values of the angles α, β and γ can vary significantly in different embodiments depending on the objectives of the application, other variables such as frame rate and speed of conveyance of the objects along the transit plane 30 and the required quality of imaging.

The example embodiment will now be described in further detail prior to presenting an example calibration procedure.

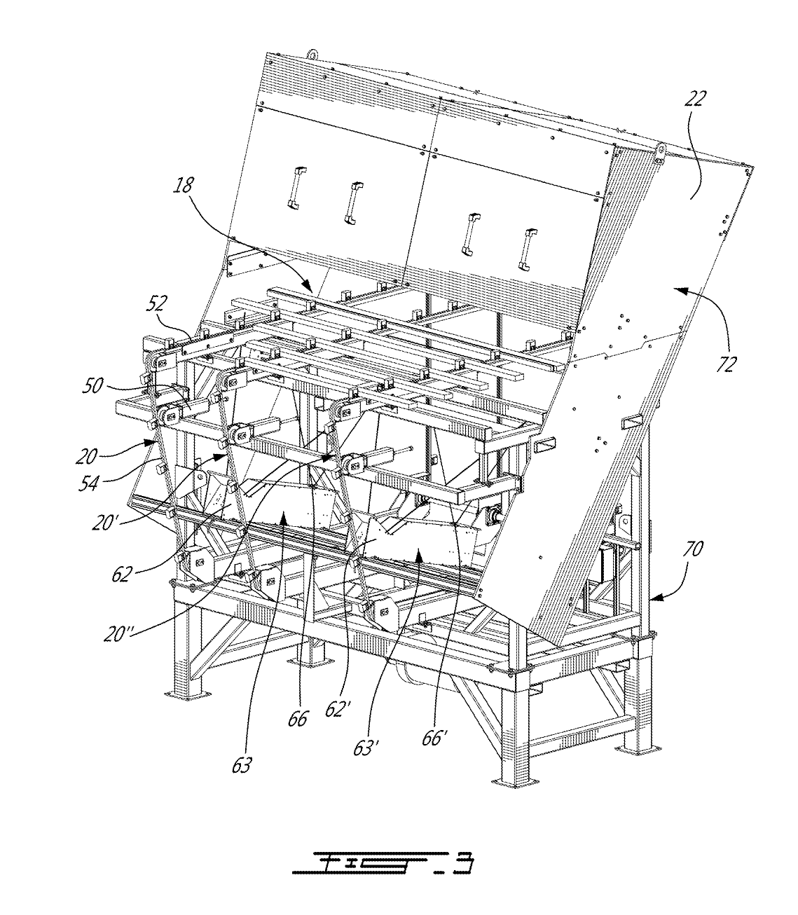

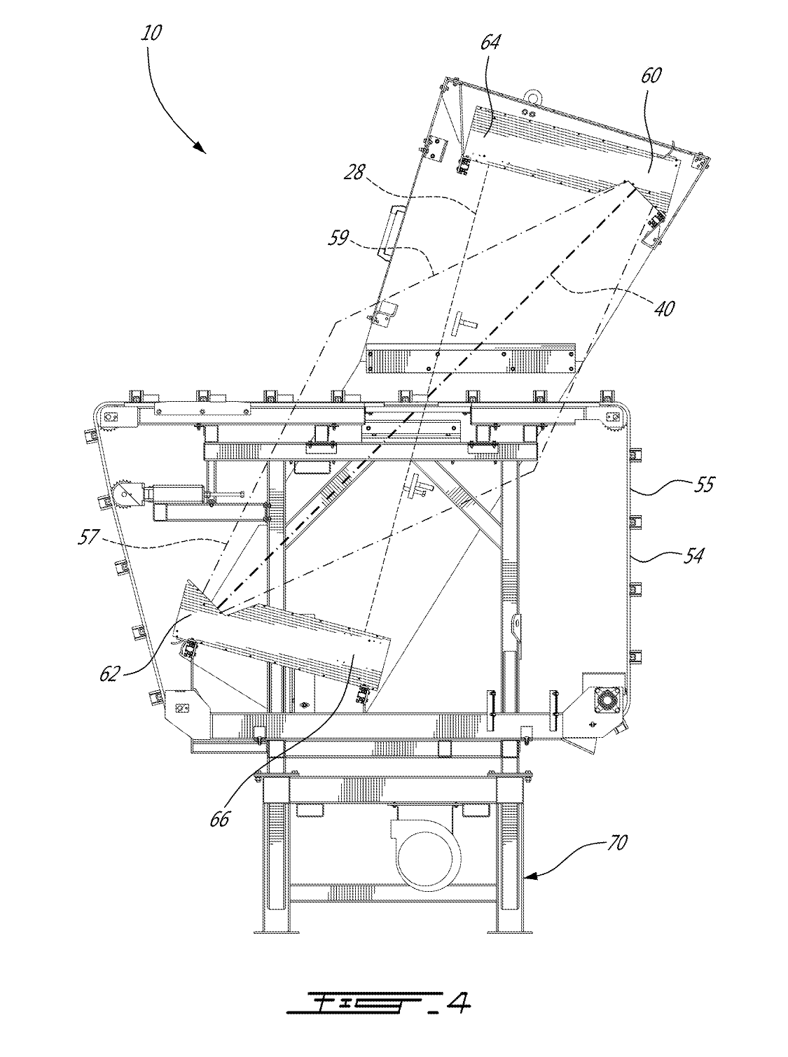

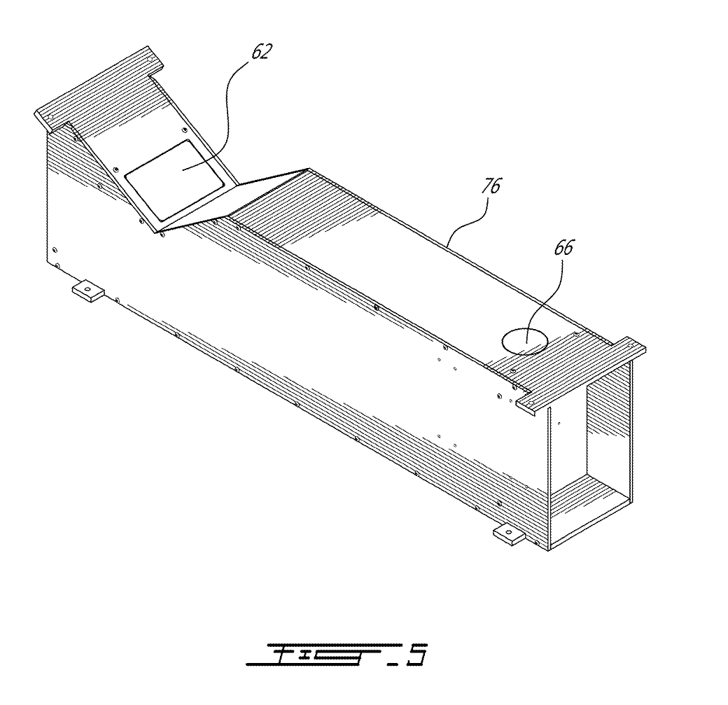

Referring to FIGS. 3 and 4, an example embodiment here has a lug chain conveyor comprised of three parallel lug chain assemblies 20, 20′, 20″ each mounted in a similar fashion to a sturdy frame 22. Each one of the lug chain assemblies has a plurality of pulleys, a tensioner 50, and a guiding rail 52 which guides the corresponding lug chain 54 along an upper horizontal portion of the lug chain path which reaches the imaging area 18. As best seen in FIG. 1, the guiding rail 52 narrows in the imaging area 18 in a manner to minimize the blind area which can be caused by the rails 52 and chains 54 to the field of view 57 of the cameras 62, 62′ positioned below the transit plane 30. For the same reason, it will be noted as shown in FIG. 5, that the cameras 62, 62′ positioned below the transit plane can be positioned within the transversal shape formed by the closed loops 55 of the chains 54, to avoid interference of the returning path of the chain with the field of view of those cameras 62, 62′. It will be understood that rail conveyors such as lug chain conveyors or alternate forms of rail conveyors using narrow belts instead of chains can be preferred over other forms of conveyors in applications where the surfaces on both sides of the objects are to be modelized, although it will be understood that simpler embodiments can use larger belt conveyors and image only the surface on one side of the objects, for instance. It will be noted here that the expression transit plane 30, as used herein, does not imply a planar path. Indeed, in alternate embodiments, the path of the boards can be curved and the transit plane be considered to be in alignment with the path of the boards at the point where it intersects the laser plane, for instance.

In this embodiment, the triple lug chain configuration of the lug chain conveyor was found satisfactory given the length of the lumber boards which the imaging system is intended to image. In order to provide satisfactory imaging along the entire length of the transversally-oriented boards, it was found satisfactory to provide two separate imaging subsystems 63, 63′ transversally interspaced from one another. More specifically, the example embodiment has two upper laser emitters (only laser emitter 64 being shown in FIG. 4), two lower laser emitters 66, 66′, two upper cameras (only upper camera 60 being shown in FIG. 4), and two lower cameras 62, 62′, each one of the upper laser emitters 64 being paired with a corresponding one of the lower laser emitters 66, 66′ and each one of the upper cameras 60 being paired with both a corresponding lower camera 62, 62′ and a pair of laser emitters 64, 66, 66′. Indeed, in this example, the laser emitters 64, 66, 66′ provide a flat beam in a given field of illumination and the cameras 60, 62, 62′ used have a given conical field of view 57 such that only two adjacent imaging subsystems 63, 63′ was found sufficient to satisfactorily image the entire length of the boards. In this embodiment, all the laser emitters were aligned in a common laser plane 28, and all the cameras were aligned in a common imaging plane 40. The cameras used were high resolution 3D cameras (˜2 Megapixels), and had a very high frame rate (˜2000 images/second). It will be noted here that in alternate embodiments, the system 10 can be scaled in a manner to adapt to longer dimensions of lumber boards, which can be achieved simply by adding transversally interspaced lug chain conveyors and imaging subsystems, and frame structure, for instance. In an alternate embodiment, it will be understood that the flat laser beam can consist of a plurality of discrete laser dots rather than a continuous laser line, for instance.

In this embodiment, the frame 22 has a base frame structure 70 generally formed of an assembly of hollow beams, and an upper frame structure 72 formed of an assembly of thick metallic plates. Both frame structures 70, 72 are made integral to the other and form a common frame 22. The lower cameras 62, 62′ and laser emitters 66, 66′ are secured to the base frame structure 70 whereas the upper cameras 60 and laser emitters 64 are secured to the upper frame structure 72 in a manner that all remain fixed in the reference system of the frame 22 while the boards 12, 14 are conveyed by the lug chains.

In this embodiment, corresponding laser emitters and the cameras (e.g. camera 62 and laser emitter 66) were incorporated into common housing 76 shown in FIG. 5. This was found useful in maintaining a temperature in a cold environment, though it can be preferred to provide independent frame mounts for the cameras and for the laser emitters in alternate embodiments in order to favour alignability independently from one another.

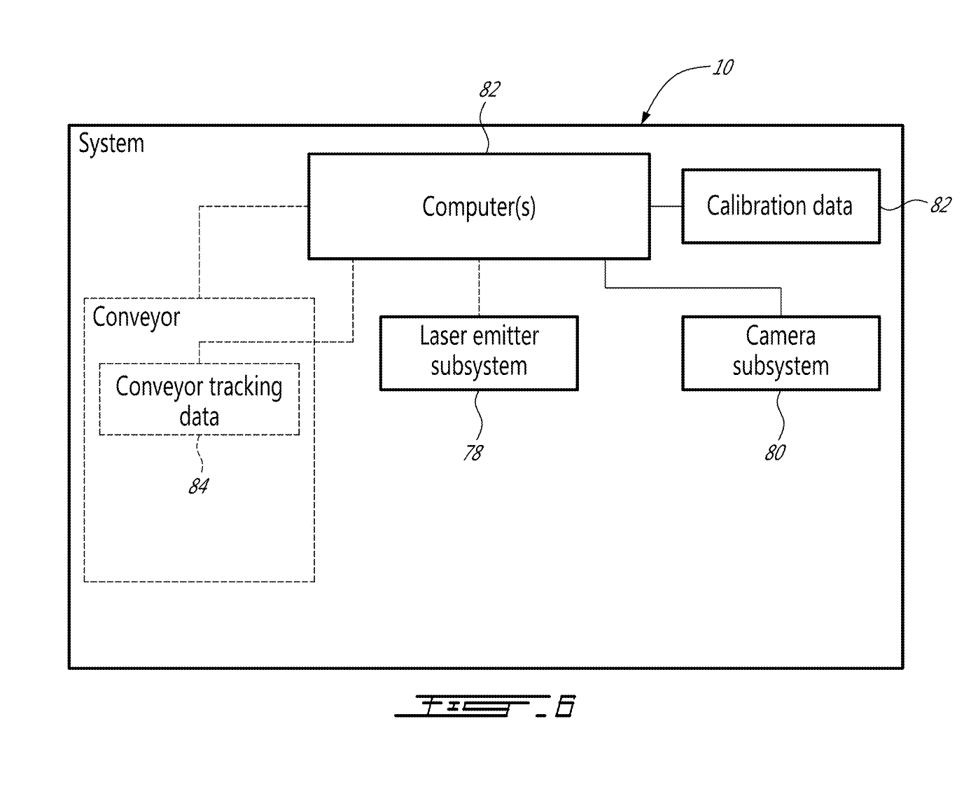

As schematized in the block diagram provided in FIG. 6, and as presented above, the system can include a laser emitter subsystem 78 including a plurality of laser emitters 64, 66, 66′, a camera subsystem 80 including a plurality of cameras (60, 62, 62′), and a computer 82 (e.g. some form of device having a processor and a memory) which can receive the images from the camera subsystem 80, identify the laser line in the images, attribute spatial coordinates to the transversal lines in the received images based on calibration data 82, and associate the coordinates to a given relative longitudinal position of the laser plane along the width of the board based on the conveyor tracking data 84. Optionally, the same computer can be used to compute both the calibration data and the conveyor tracking data, and this same computer can further be used in controlling the conveyor and the laser emitters. Different computers can be used to achieve different ones of these tasks and be provided with wired or wireless means of communicating with one another in alternate embodiments.

Having discussed the general use of the system, and an example embodiment, an example calibration method for the cameras will now be described.

It will be stressed here that insufficient sturdiness of the frame 22 can have an effect not only on the reliability/precision of the system during use, but also on the calibration, or on the ability of the system to remain calibrated for a given period of time. Indeed, the frame 22 is used to maintain the laser emitter subsystem (and thus the laser plane) and the camera subsystem (and thus their points of view) at fixed positions relative to the frame reference system as the objects are longitudinally moved relative to the laser plane 28 along the transit plane 30.

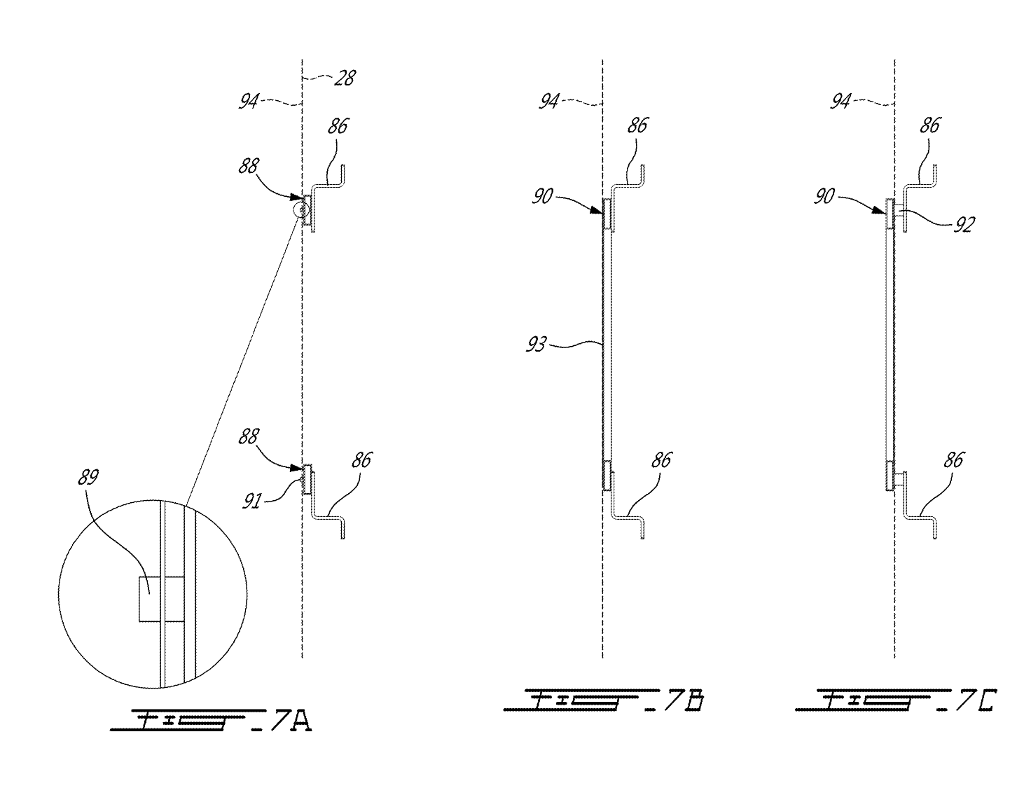

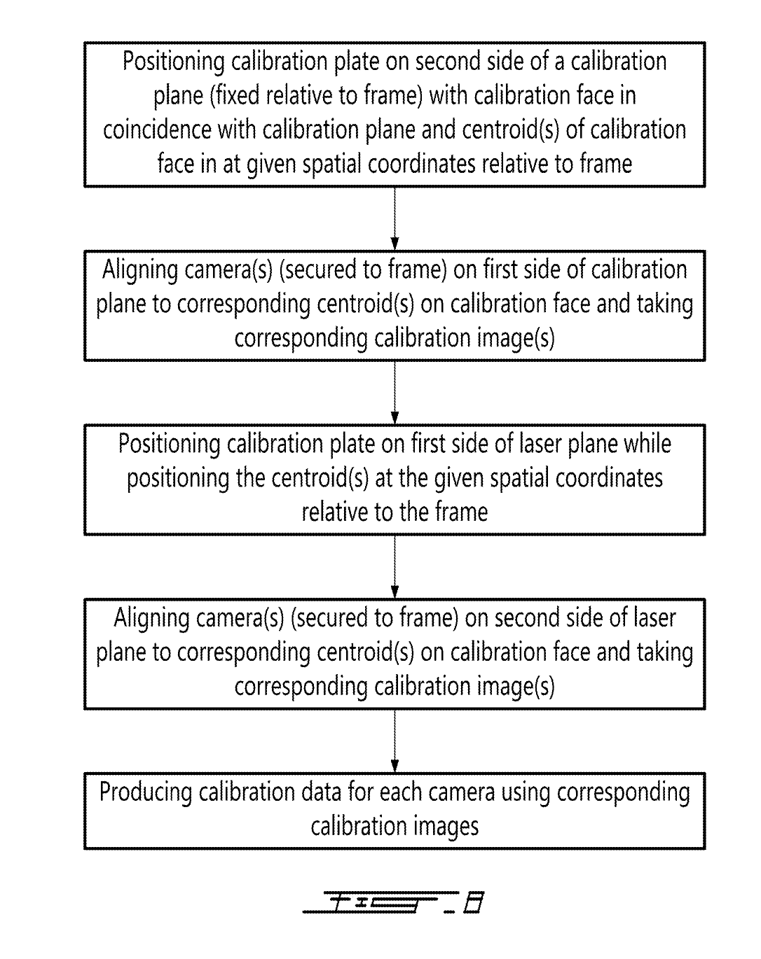

In this embodiment, a calibration subframe 86, as best shown in FIG. 8, is made sturdily integral to the frame 22 and is adapted to receive calibration implements (e.g. 88, 90 and 92 shown in FIGS. 7A, 7B, 7C) along a predetermined calibration plane 94. The laser emitters can be aligned along the calibration plane 94 and the calibration plane 94 can subsequently coincide with and be referred to as the laser plane 28. The alignment of the laser emitters with the calibration plane can be performed before or after the calibration of the cameras with the calibration plane in alternate embodiments. This description will begin by detailing an example of laser alignment for purely arbitrary reasons.

The laser emitters can be aligned by securing a laser alignment implement 88 to the calibration subframe 86. In this embodiment, the laser alignment implement 88 includes an upper laser alignment bar 89 and a lower laser alignment bar 91 (seen in FIG. 7A). Both laser alignment bars 89, 91 have a plurality of transversally interspaced laser alignment blocks, as best shown in the enlarged portion of FIG. 7A, which have a laser alignment notch on the upper and lower faces thereof. The laser alignment implement 88 is configured in a manner that when secured in the predetermined position on the calibration subframe 86, the laser alignment notches precisely match the predetermined position of the calibration plane 94. Moreover, the laser alignment blocks of the upper bar 89 can be transversally interspersed with the laser alignment blocks of the lower bar 91. Accordingly, the upper laser emitters can be operated and aligned with the calibration plane 94 based on the alignment of the laser light they emit with the upper alignment notches of both the upper and lower alignment bars 89, 91 (a portion of the flat beam passing between adjacent ones of the upper alignment blocks and onto the lower alignment block positioned therebetween), and the lower laser emitters can be operated and aligned with the calibration plane based on the alignment of the laser light they emit with the lower alignment notches of both the upper and lower alignment bars 89, 91.

The cameras can be calibrated using a camera calibration implement 90 having a planar calibration face 93. The camera calibration implement 90 and the calibration subframe 86 are configured in a manner that the camera calibration implement 90 can be received in a first predetermined position on the calibration subframe (illustrated in FIG. 7B). In the first predetermined position, a body of the camera calibration implement 90 is on a first side of the calibration plane 94 and a calibration face 93 precisely coincides with the calibration plane 94 (or laser plane). The calibration face 93 of the camera calibration implement has reference features thereon including, in this particular embodiment, a centroid marking for each camera. Accordingly, cameras on the second side of the calibration plane 94 can be aligned with the centroid marking, and an image of the reference features can be taken. The image of the reference features can be processed by a computer and based on measurements taken of the reference features in the image (which are affected by the relative position and orientation of the calibration face relative to the point of view of the camera), the position and orientation of the calibration face relative to the point of view of the camera, and hence the relative position and orientation of the calibration plane 94, can be established and used to produce calibration data 82. The calibration data 82 can then be used to interpret the position and shape of the transversal laser lines on the images of the boards.

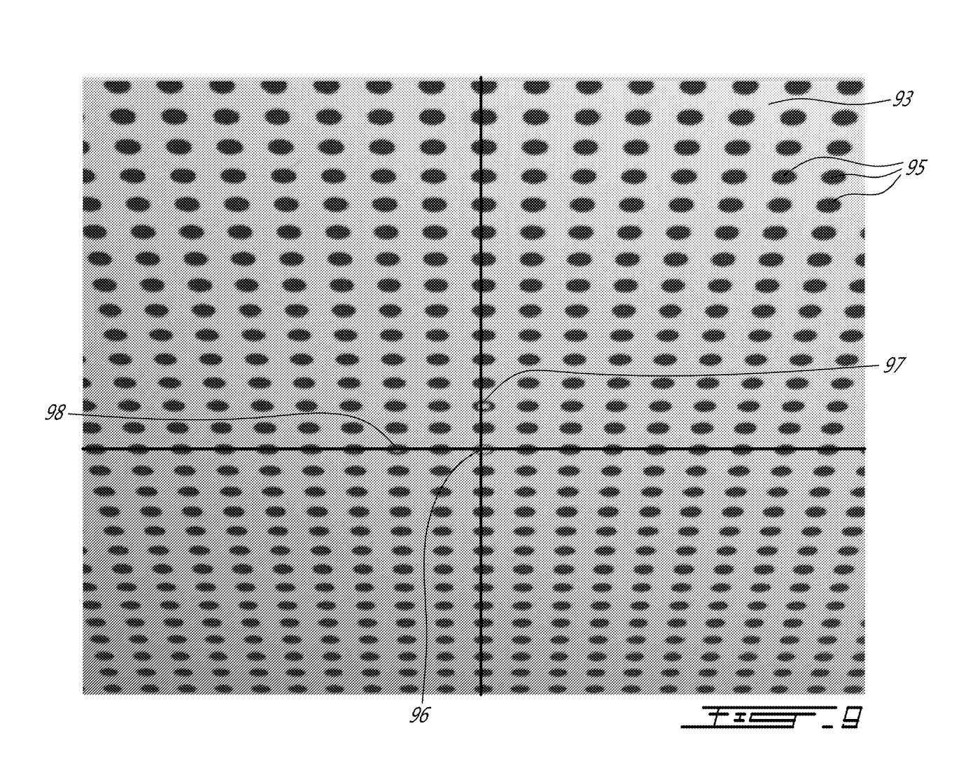

The calibration of the cameras on the other side of the laser plane can be performed independently of the calibration described above, as follows. The camera calibration implement 90 is received in a second predetermined position on the calibration subframe 86 (illustrated in FIG. 7C) in a manner that a main body of the camera calibration implement 90 is on the first side of the laser plane, and spacers 92 can be used to precisely gauge the distance between the calibration subframe 86 and the calibration face 93 of the camera calibration implement 90 in a manner that the calibration face 93 precisely coincides with the laser plane 94 and in a manner that the centroids of the calibration face precisely occupy the same spatial coordinates as when in the first predetermined position (shown in FIG. 9B). The spacers 92 can be provided separately, or made integral to, the camera calibration implement 90. Accordingly, the cameras on the first side of the laser plane can be calibrated based on the reference features on the calibration face in the process of producing calibration data. It will be understood above that alternately to beginning with the calibration of the cameras on the first side, the calibration of the cameras can be begun with the calibration of the cameras on the second side, and vice-versa.

FIG. 8 provides a flowchart summarizing the steps presented above.

In the embodiment described above, the calibration implements 88, 90, 92 are removably securable to the calibration subframe 86, itself being made integral to the frame 22. Any method likely to induce significant torsion into the calibration subframe should be rejected as this may cause distortion of the calibration subframe during calibration which can lead to inaccuracy or malfunction during later use. It was found in this specific embodiment that securing the predetermined positions of the camera calibration module using locating pins engaged in precisely machined holes and then clamping was effective.

In this specific embodiment, the reference features of the calibration face include an array of regularly interspaced dots all having the same diameter, in a manner that the measurement of the distance between a corresponding number of adjacent dots on the images can be used as a basis to determine the position and orientation of the laser plane relative to the point of view of the camera having taken the picture.

FIG. 9 shows an enlarged portion of a raw image of the calibration face 93 of the specific camera calibration implement 90 which was used in this embodiment. As depicted, the camera calibration implement has a plurality of reference features including a regular array of dots 95 all having the same diameter. In alternate embodiments, the exact pattern used can vary. One of the dots 96 has a circular marking of a contrasting color therein and is used as the centroid 96. The calibration can involve aligning a vertical line mark 97 with a column of dots including the centroid 96 and aligning the horizontal line mark 98 with a row of dots including the centroid 96. In another embodiment, the horizontal line mark can correspond to the central axis and the vertical line mark is aligned with the laser plane and perpendicular with the horizontal line mark. The terms “horizontal” and “vertical” are not meant to be read limitatively so the line marks are not limited to the horizontal and to the vertical orientations.

When aligning the camera with the camera calibration implement, it is understood that the alignment mark stays fixed relative to the point of view of the camera in the image so that when an operator, for instance, adjusts the spatial alignment of the corresponding camera, the matrix of dots translates “under” the alignment mark which can guide the operator in the aligning the alignment mark with the centroid mark 96. The operator can thus straightforwardly adjust the spatial alignment of the camera such that the horizontal line mark is collinear with a row of dots and that the vertical line mark is collinear with a column of dots, with the centroid mark at the intersection of the two line marks. This alignment procedure generally requires a satisfactory lighting.

Although the alignment mark of the camera seems to encompass the full field-of-view of the camera as shown in FIG. 9, this image is only an enlarged portion of the raw image. Accordingly, the alignment mark does not necessarily need to extend across the whole raw image, but only to a sufficient quantity of dots deemed satisfactory in the circumstances.

In practice, the raw image of the camera calibration implement can be processed by a computer to trim portions of the raw image, adjust the contrast, adjust the luminosity, adjust the color and the like prior to performing the artificial vision algorithm which recognizes, and measures, the dots of the image. Trimming useless portions of the raw image (i.e. the exterior of the camera calibration implement) can help prevent the computer to erroneously associate some structures of the system to the reference features of the camera calibration implement.

Referring back to FIG. 9, some reference features, including the centroid marking, can have a signature shape in order to suitably distinguish the reference features to one another. These signature shapes can help, in some embodiments, to identify the upper portion of the camera calibration implement from the lower portion thereof, or alternately, identify the leftmost portion of the camera calibration implement from the rightmost portion thereof, for instance. In the illustrated example, the distinguishable reference features are provided in the form of rings having different internal diameters, which help distinguishing the signature shapes properly.

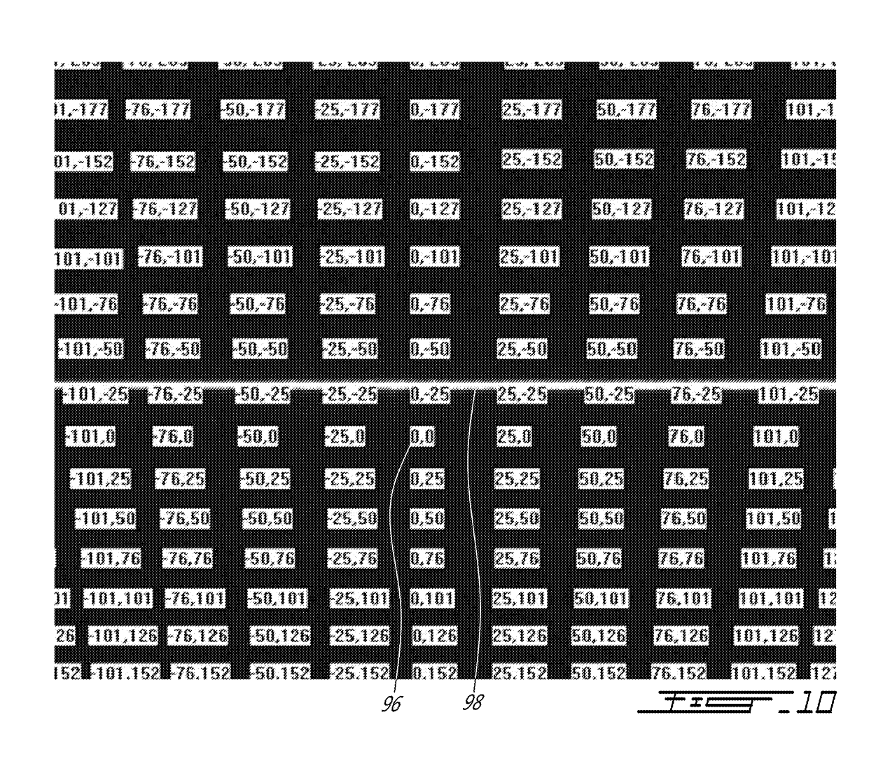

Once the image is properly processed, the computer can be used to correlate a spatial coordinate to each of the reference features. Accordingly, FIG. 10 shows a coordinate reference mapping showing a spatial coordinate attributed to each reference feature, with the centroid mark 96 having the horizontal spatial coordinate “zero” and also the vertical spatial coordinate “zero” (i.e. 0,0), for instance. FIG. 10 also shows an example of a laser line 1502 illuminating the lumber board (not seen in FIG. 10). In this illustrated embodiment, the laser line is aligned with the vertical spatial coordinate “−0.25”, for instance. In the event of a misaligned camera, the laser line would not appear to be parallel with any one of the rows of dots, or one of the rows of spatial coordinates sharing the same vertical spatial coordinates.

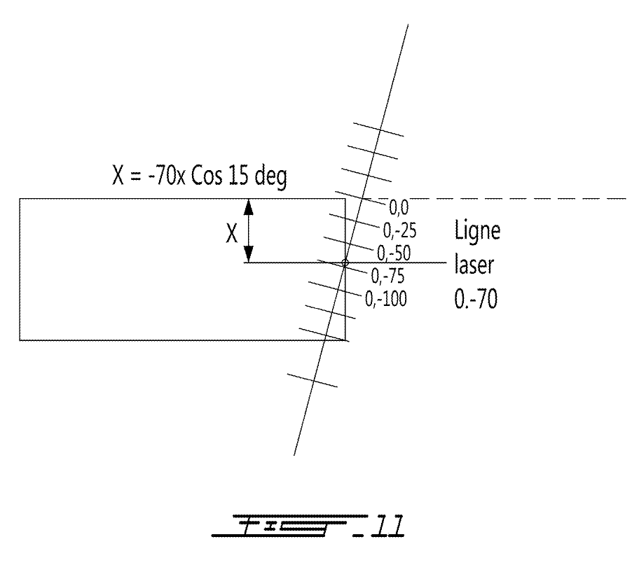

FIG. 11 schematizes the calculation based on the inputs received. A cross-section of a lumber board is shown. The laser line forms an angle of inclination α of 75° relative to the lumber path. The “vertical” spatial coordinate c along the laser plane can be used in order to triangulate the position X at which the laser line illuminates the lumber board using the trigonometric relation X=c·cos 15°.

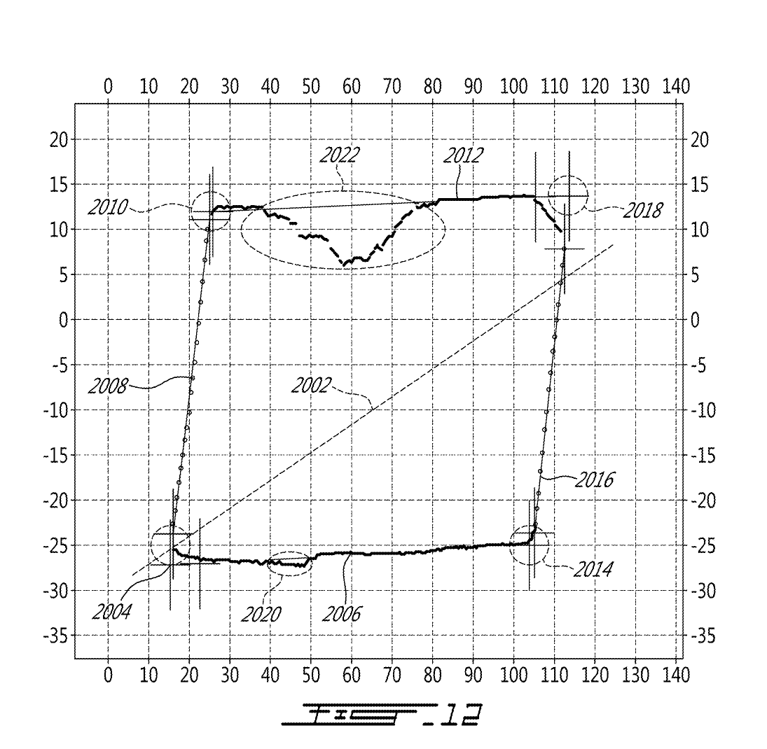

FIG. 12 shows a lumber board profile at a given point along the length of the lumber board, which was measured with the system disclosed herein. It can be seen that the lumber board profile has points which correspond to actual portions of the scanned lumber board. The points along the bottom face and the leading edge of the lumber board (below diagonal 2002) have been measured using one camera and the points along the upper face while the trailing edge of the lumber board (above diagonal 2002) have been measured using the other camera, for instance. The points associated with a given edge or with a given face of the lumber board can be joined to one another to form a boundary of the cross-section of the lumber board. It is contemplated that the boundaries of the lumber board can be used to determine a thickness and a width of the lumber board. In an embodiment, the intersection between the boundaries can help determining the thickness or the width of the lumber board. For instance, subtracting the vertical spatial coordinate of an intersection 2004 between a lower face boundary 2006 and a trailing edge boundary 2008 from the vertical spatial coordinate of an intersection 2010 between an upper face boundary 2012 and the trailing edge boundary 2008 can provide a measure of the thickness of the lumber board. In another embodiment, subtracting the vertical spatial coordinate of an intersection 2014 between the lower face boundary 2006 and a leading edge boundary 2016 from the vertical spatial coordinate of an intersection 2018 between the upper face boundary 2012 and the leading edge boundary 2016 can provide another measure of the thickness of the lumber board. In a further embodiment, these two measures of the thickness can be averaged to provide an averaged thickness of the lumber board. Of course, the averaged thickness can be based on more than two measures thicknesses. These measuring methods also apply for measuring the width of the lumber board. It is noted that other measuring methods can be used depending on the circumstances and on the degree of precision required.

It is understood that the points of the lumber board profile that are positioned away from the determined boundaries (with respect to a given tolerance value) are collectively referred to as with defects (such as shown at 2020 and at 2022) of the lumber board such as cracks, depressions, decays and the like. With such a lumber board profile, the physical characteristics of the lumber board can thus be determined.

It will be noted that, in the transversal orientation corresponding to the length of the boards, the computer can be adapted to compute profiles for a number of discrete points extending along the laser line, and that the distance between these points can be adapted as a function of the desired level of precision and/or of limitations of the equipment.

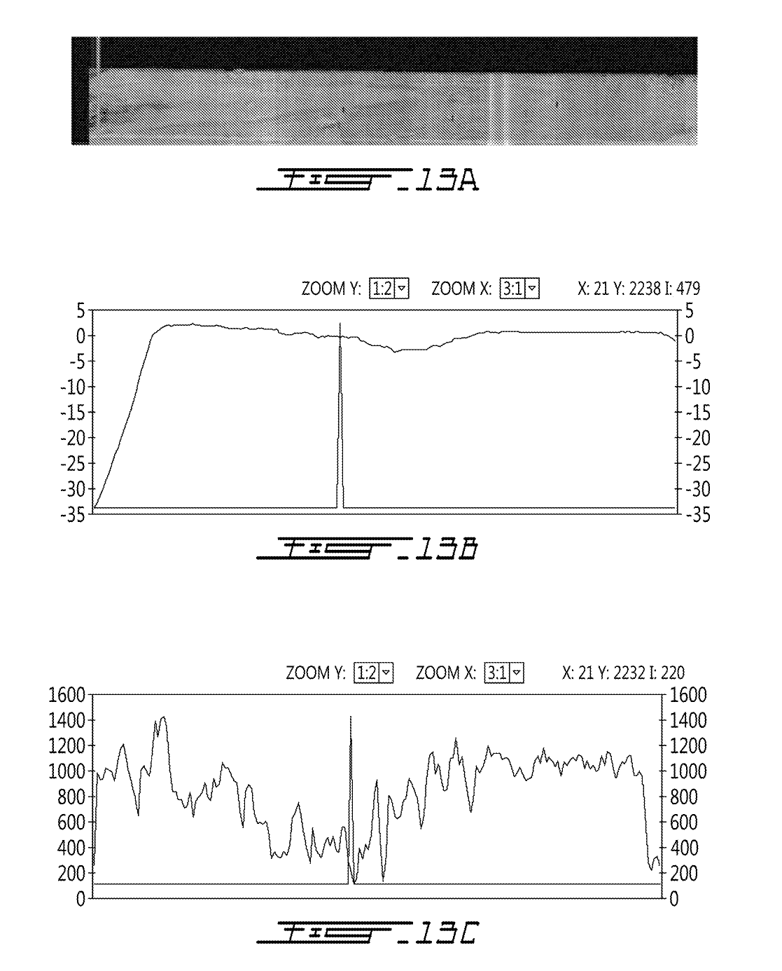

FIG. 13A shows an image of an upper face of a lumber board along its length taken with a camera of the system described herein. FIG. 13B shows an exemplary graph of the color data (e.g. the intensity of the reflected laser line) as a function of a cross-section taken along the length of the lumber board. FIG. 13C shows an example of the color data as a function of a cross-section taken along the width of the lumber board. Since each point is associated with an intensity of the imaged laser line, these lumber board profiles can help identifying knots or wanes along the surface of the lumber board.

As can be understood, the examples described above and illustrated are intended to be exemplary only. For instance, the method and system can be adapted to image other objects than lumber boards and the extent of the portion of the object being imaged can vary in alternate embodiments. In cases of boards, it is practical that the imaging system be fixed while the boards are conveyed by the conveyor, though it will be understood, in alternate embodiments, that the reference system of the imaging system can be moved while the objects remain fixed in order to obtain a workable relative movement therebetween. It will be further noted here that in alternate embodiments, the referencing of the transversal laser lines into a 3D model of the object can be performed based on stereoscopic vision of cameras rather than by 2D images, and accordingly, the calibration data can take various forms. In light of the above, the scope is indicated by the appended claims.

1. A method of imaging a lumber board as the lumber board is being conveyed along a longitudinal transit plane by a conveyor, the conveyor having a frame, a conveyor reference system being fixed in relation to the frame, the method comprising:
emitting laser light along a laser plane and toward the transit plane from both opposite sides of the transit plane, in a manner to form a corresponding pair of opposite transversal lines of laser light on the lumber board as the lumber board is conveyed across the laser plane, the laser plane intersecting both the transit plane and a plane normal to the transit plane, along a central axis;
from points-of-view on both sides of the transit plane and spaced apart from the laser plane, recording a plurality of images of the transversal lines of laser light as the lumber board is conveyed across the laser plane, with each image being associated to a corresponding longitudinal position of the lumber board along the transit plane; and
using a computer, producing a mapping of the geometry of the board by correlating, for each one of the images, the position of a plurality of points located along the transversal lines of laser light in the recorded images with tridimensional coordinates in the conveyor reference system using tracking data indicative of the movement of the lumber board as it is conveyed across the laser plane, and calibration data associated to the corresponding points-of-view.

2. The method of claim 1 wherein the step of recording includes recording a detected intensity of light for each of the points located along the transversal lines of laser light.

3. The method of claim 2 wherein the step of producing a mapping of the geometry of the board includes correlating a value of the detected intensity for each one of the tridimensional coordinates in the conveyor reference system.

4. The method of claim 3 wherein the step of producing a mapping of the geometry of the board further includes interpolating an intensity of points located between successive ones of the transversal lines of laser light based on the correlated values of the detected intensity of adjacent ones of the points.

5. The method of claim 3 further comprising using the computer, determining the position and size of a color defect based on the correlated intensity values, and generating a signal indicative of the position and size of the color defect.

6. The method of claim 1 wherein the points-of-view include at least a pair of points-of-view each being positioned in a common imaging plane on an opposite side of the transit plane, the common imaging plane intersecting all of the transit plane, the normal plane, and the laser plane along the central axis.

7. The method of claim 6 wherein both the imaging plane and the laser plane are inclined from the transit plane by between 10° and 80° and are inclined from one another by at least 10°.

8. The method of claim 7 wherein both the imaging plane and the laser plane are inclined from the transit plane by between 15° and 75° and are inclined from one another by at least 20°.

9. The method of claim 6 wherein the imaging plane is inclined from the transit plane by 45°.

10. The method of claim 1 wherein the step of producing a mapping of the geometry of the board further includes interpolating tridimensional coordinates of points located between successive ones of the transversal lines of laser light based on the correlated tridimensional coordinates of adjacent ones of the points.

11. The method of claim 1 wherein the transversal lines are continuous.

12. The method of claim 1 wherein the transversal lines are formed by a plurality of regularly interspaced dots.

13. A system for imaging a lumber board as the lumber board is being conveyed along a longitudinal transit plane by a conveyor, the conveyor having a frame and a conveyor reference system associated to the frame, the system comprising:
a laser emitter subsystem having a plurality of laser emitters being mountable to the frame for emitting laser light, along a common laser plane, toward the transit plane, and from both opposite sides of the transit plane, in a manner to form a corresponding pair of opposite transversal lines of laser light on the lumber board as the lumber board is conveyed across the laser plane, the common laser plane intersecting both the transit plane and a plane normal to the transit plane along a central axis;
a camera subsystem having a plurality of cameras being mountable to the frame for recording a plurality of images of the transversal lines of laser light as the lumber board is conveyed across the laser plane, at corresponding points-of-view being fixed in the conveyor reference system, located on each side of the transit plane, and being spaced apart from the laser plane, the camera subsystem being connectable to transfer the recorded images onto a computer;
a tracking subsystem for tracking the movement of the lumber board as it is conveyed across the laser plane and producing tracking data indicative thereof, the tracking subsystem being configured and adapted to transmit a data feed to the computer; and
a software program product loadable to the computer and having a set of instructions executable by the computer for producing a mapping of the geometry of the board by correlating the position of a plurality of points located along the transversal lines of laser light in the recorded images with tridimensional coordinates in the conveyor reference system using the tracking data, and calibration data associated to the corresponding points-of-view.

14. The method of claim 13 wherein the cameras are cameras further adapted to record a detected intensity of light for each of the points (pixels) located along the transversal lines of laser light.

15. The method of claim 13 wherein the points-of-view include at least a pair of points-of-view each being positioned in a common imaging plane on an opposite side of the transit plane, the common imaging plane intersecting all of the transit plane, the normal plane, and the laser plane along the central axis.

16. The method of claim 15 wherein both the imaging plane and the laser plane are inclined from the transit plane by between 10° and 80° and are inclined from one another by at least 10°.

17. The method of claim 16 wherein both the imaging plane and the laser plane are inclined from the transit plane by between 15° and 75° and are inclined from one another by at least 20°.

18. The method of claim 15 wherein the imaging plane is inclined from the transit plane by 45°.

19. The system of claim 13 in combination with the conveyor and the computer.

20. The system of claim 19 wherein the conveyor is a lug chain conveyor with a plurality of transversally spaced apart, closed-loop lug chains configured for receiving and conveying transversally-oriented lumber boards.

21. The method of claim 20 wherein at least one of the points-of-view is located within a volume enclosed by loops of the closed-loop lug chains.

22. A method of imaging an object moving along a longitudinal transit plane relatively to a reference system, the method comprising:
emitting laser light, along a laser plane being fixed in the reference system and toward the transit plane, in a manner to form a transversal line of laser light on the object as the object is moved across the laser plane in the reference system, the laser plane intersecting both the transit plane and a plane normal to the transit plane along a central axis;
recording a plurality of images of the transversal line of laser light as the object is moved across the laser plane, from at least one point-of-view being fixed in the reference system and being spaced apart from the laser plane;
tracking the movement of the object as it is conveyed across the laser plane and producing tracking data indicative thereof; and
using a computer, producing a mapping of the geometry of at least a portion of the object by correlating the position of a plurality of points located along the transversal line of laser light in the recorded images with tridimensional coordinates in the reference system using the tracking data, and calibration data associated to the at least one point-of-view.

23-27. (canceled)
